(19) United States
(12) Patent Application Publication
(10) Pub. No.: US 2023/0134738 A1
(43) Pub. Date: May 4, 2023

(54) Method for Preventing a Non-Authorized Using of an Aerosol Generation Device in a Restricted Area and Associated System

(71) Applicant: JT International SA, Geneva (CH)

(72) Inventors: Andrew Robert John Rogan, Forres (GB); Stephane Hedarchet, Geneva (CH)

(73) Assignee: JT International SA, Geneva (CH)

(21) Appl. No.: 17/911,749

(22) PCT Filed: Mar. 18, 2021
(86) PCT No.: PCT/EP2021/056914

§ 371 Date: Sep. 15, 2022

(30) Foreign Application Priority Data
Mar. 20, 2020 (EP) 20164614.8

(51) Int. Cl. A24F 40/53; A24F 40/65; A24F 40/57

(52) U.S. Cl. CPC A24F 40/53; A24F 40/65; A24F 40/57

(57) ABSTRACT

The present invention concerns a method (60) for preventing a non-authorized using of an aerosol generation device in a restricted area, comprising the steps of determining (61) a travelling speed; determining (65), if said speed is above a predetermined threshold, that the aerosol generation device is in the restricted area and disabling device; determining (67) a device characteristic of the aerosol generation device; comparing (71) the device characteristic with an updatable database to generate a second control signal; and transmitting (73) to the device a second control signal causing normal operation of the aerosol generation device or adjusted operation the aerosol generation device according to the restrictions of the restricted area.

### FIELD OF THE INVENTION

The present invention concerns a method for preventing a non-authorized using of an aerosol generation device in a restricted area.

The present invention concerns also a system configured to implement such a method.

### BACKGROUND OF THE INVENTION

Different types of aerosol generation devices are already known in the art. Generally, such devices comprise a storage portion for storing an aerosol forming precursor, which can comprise for example a liquid or in a form of tobacco stick. A heating system is formed of one or more electrically activated resistive heating elements arranged to heat said precursor to generate the aerosol. The aerosol is released into a flow path extending between an inlet and outlet of the system. The outlet may be arranged as a mouthpiece, which a user inhales through for delivery of the aerosol.

In some areas, using of an aerosol generation devices can be restricted or even prohibited. Such areas may be notably public transport or any other kind of transport.

In order to prevent a non-authorized using of an aerosol generation device in such areas, called hereinafter restricted areas, different methods making it possible to disable operation of the aerosol generation devices in these areas are already known in the state of the art.

Thus, for example, one of these methods consists in diffusing a special wireless beacon in the restricted area. Upon receiving such a wireless beacon, switching means comprised in each aerosol generation device are configured to disable the operation of the corresponding device. The device can be operated again when no wireless beacon is received that means that the device is no longer in the restricted area.

Some other methods consist in determining the location of an aerosol generation device using for example a GPS receiver and comparing this location with a memorized map comprising restricted areas. When the device is in a restricted area according to this map, its operation is disabled. It can be then enabled when the device is no longer in such an area.

However, the existing methods are not completely satisfactory. According to some of them, it may be difficult to determine if the aerosol generation device is in a restricted area and/or what kind of restrictions are in force in these restricted areas. In some restricted area where only relatively low-level limitations (instead of completely forbidding use of all aerosol generating devices) are imposed, the operation of some modern aerosol generation devices can be adjusted basing on the restrictions imposed by the restricted area (e.g., fulfilling all requirements of standards of the restricted area) so as using of these devices can be authorized in such an area. The existing methods do not allow distinguishing such devices which can be authorized to operate in spite of the restrictions.

### SUMMARY OF THE INVENTION

One of the aims of the invention is to improve the existing methods and make it possible to determine if the aerosol generation device is in a restricted area and authorize or disable generating aerosol by such a device taking into consideration of inherent characteristics of this device in addition to the restrictions imposed by the area.

For this purpose, the invention relates to a method for preventing a non-authorized using of an aerosol generation device in a restricted area, the aerosol generation device comprising a control unit configured to adjust the operation of the aerosol generation device according to operational settings upon receiving a control command;

the method comprising the following steps:
determining a travelling speed of the aerosol generation device;
if the travelling speed of the aerosol generation device is above a predetermined threshold or equal to this threshold, determining that the aerosol generation device is in the restricted area and transmitting to the control unit of the device a first control signal causing disabling the aerosol generation device to generate aerosol;
determining a device characteristic of the aerosol generation device;
comparing the device characteristic of the aerosol generation device with an updatable database to generate a second control signal, the database comprising control characteristics defining restrictions in the restricted area;
transmitting to the control unit of the aerosol generation device the second control signal, the second control signal causing normal operation of the aerosol generation device or adjusted operation the aerosol generation device according to the restrictions of the restricted area.

Using these features, the method according to the invention makes it possible to determine a restricted area, as for example a public transport or any other kind of transport, determine a characteristic of the device and basing on this characteristic, authorize or not using the aerosol generation device to generate aerosol in the restricted area. It is also possible to adjust some operational settings of the aerosol generation device so as its operation could be authorized according to the restrictions.

According to some embodiments, the method further comprises the following step:
if the travailing speed is below said predetermined threshold, preferably during a time period longer than a predetermined time threshold, transmitting to the control unit of the aerosol generation device a third control signal causing enabling normal operation of the aerosol generation device.

Using these features, the method can determine when the aerosol generation device is no longer in the restricted area.

According to some embodiments, the travelling speed is determined using a GNSS receiver.

Using these features, it is possible to determine the travelling speed with a high precision.

According to some embodiments, wherein the step of determining the travelling speed is performed by the aerosol generation device or by a mobile device associated to the aerosol generation device.

Using these features, the travelling speed can be provided directly by the aerosol generation device or by the mobile device associated to this device.

According to some embodiments, the step of determining the device characteristic is performed by a processor of the aerosol generation device by a pre-programmed routine.

Using these features, the method according to the invention can be performed by the aerosol generation device.

According to some embodiments, the step of determining the device characteristic is performed by a scan terminal disposed in the restricted area by scanning the aerosol operation device or a mobile device associated to the aerosol generation device.

Using these features, it is possible to use scan terminals, for example upon entering the restricted area, to determine at least one characteristic of the device.

According to some embodiments, the method further comprises the step of transmitting the device characteristic to a distant server.

According to some embodiments, the step of transmitting the device characteristic is performed by the scan terminal.

According to some embodiments, the step of transmitting the device characteristic is performed by the aerosol generation device or a mobile device associated to the aerosol generation device.

Using these features, different ways of data transmission to the distant server can be performed.

According to some embodiments, each control characteristic of the updatable database comprises at least one element chosen in the group comprising:
brand and/or model of aerosol generation devices authorized or non-authorized to be used in the restricted area according to the emission restrictions;
identifier of aerosol generation devices authorized or non-authorized to be used in the restricted area according to the emission restrictions;
identifier of payloads authorized or non-authorized to be used in the restricted area according to the emission restrictions;
thresholds of authorized emission composition of the aerosol.

Using these features, it is possible to obtain the updatable database making it possible to adjust the operation of the aerosol generation device according to the restrictions imposed in the restricted area.

According to some embodiments, the device characteristic comprises at least one element chosen in the group comprising:
brand and/or model of the aerosol generation device;
identifier of the aerosol generation device;
identifier of the payload;
emission composition of the aerosol.

Using these features, it is possible to determine at least one device characteristic so as to compare it with control characteristics from the updatable database.

According to some embodiments, adjusting the operation of the aerosol generation device includes at least one element chosen in the group comprising:
heater temperature control;
aerosol composition control;
power control;
pressure control.

Using these features, it is possible to adjust the operation of the aerosol generation device so as to satisfy the restrictions imposed by the restricted area.

According to some embodiments, the restricted area is a public transport.

According to some embodiments, the second control signal prevails over the first control signal.

Using these features, it is possible to perform the steps of the method in different orders. Particularly, when the first control signal is received after receiving the second control signal, the first control signal has no effect, i.e. it will not cause disabling the aerosol generation by the aerosol generation device.

The invention also relates to a system for preventing a non-authorized using of an aerosol generation device in a restricted area, configured to implement the method as defined above.

### BRIEF DESCRIPTION OF THE DRAWINGS

The invention and its advantages will be better understood upon reading the following description, which is given solely by way of non-limiting example and which is made with reference to the appended drawings, in which:

FIG. 1 is a schematic diagram showing an aerosol generation device;

FIG. 2 is a schematic diagram showing a system for preventing a non-authorized using of an aerosol generation device, according to a first embodiment of the invention;

FIG. 3 is a flowchart of a method for preventing a non-authorized using of an aerosol generation device, performed by the system of FIG. 2;

FIG. 4 is a schematic diagram showing a system for preventing a non-authorized using of an aerosol generation device, according to a second embodiment of the invention;

FIG. 5 is a schematic diagram showing a system for preventing a non-authorized using of an aerosol generation device, according to a third embodiment of the invention.

### DETAILED DESCRIPTION OF THE INVENTION

Before describing the invention, it is to be understood that it is not limited to the details of construction or process steps set forth in the following description. It will be apparent to those skilled in the art having the benefit of the present disclosure that invention is capable of other embodiments and of being practiced or being carried out in various ways.

As used herein, the term “aerosol generation device” or “device” may include a smoking device to deliver an aerosol to a user, including an aerosol for smoking, by means of aerosol generating unit (e.g. a heater or atomizer which generates vapor which condenses into an aerosol before delivery to an outlet of the device at, for example, a mouthpiece, for inhalation by a user. The device may be portable. “Portable” may refer to the device being for use when held by a user. The device may be adapted to generate a variable amount of aerosol, e.g. by activating an atomizer for a variable amount of time (as opposed to a metered dose of aerosol), which can be controlled by a trigger. The trigger may be user activated, such as a vaping button and/or inhalation sensor. The inhalation sensor may be sensitive to the strength of inhalation as well as the duration of inhalation so as to enable more or less vapor to be provided based on the strength of inhalation (so as to mimic the effect of smoking a conventional combustible smoking article such as a cigarette, cigar or pipe, etc.). The device may include a temperature regulation control to drive the temperature of the heater and/or the heated aerosol generating substance (aerosol pre-cursor) to a specified target temperature and thereafter to maintain the temperature at the target temperature regardless of the amount of substrate (pre-cursor) available at the aerosol generating unit and regardless of the strength with which a user inhales. More generally, the aerosol generation device can comprise a control unit configured to adjust the device according to operational settings. Thus, the control unit can control the operation of the heater and/or the power provided for example by a battery and/or the pressure of the precursor or the air.

As used herein, the term “operational settings” may refer to settings usable by the control unit of the device to control the operation of the device. The operational settings may thus refer to a temperature of the heater and/or current or voltage values provided by the battery and/or precursor or air pressure values. The operational settings may be normal and adjusted. The normal operational settings are used when the device is operated normally, i.e. without restrictions. In this case, all functions of the device are workable in a default setting or in a default operation mode to enable full capacity of aerosol generation. The adjusted operational settings are used when the device is operated under restrictions imposed for example by the area where the device is used. The adjusted operational setting may adjust or limit some functions of the device, e.g., lower down the aerosol emission of the device. So, the adjusted operational settings make it possible to respect the restrictions. The adjusted operational settings can cause disabling operation of the aerosol generation device.

As used herein, the term “control signal” may refer to a signal transmitted to the control unit of the aerosol generation device to cause a modification in the operation of the device. For example, a control signal can cause a modification of the operational settings by the control unit of the device. A control signal can also include operational settings to be used by the control unit. According to other examples, a control signal can include an enabling signal causing normal operation of the device to generate aerosol, i.e. using normal operational settings by the control unit, an adjusting signal causing adjusted operation of the device to generate aerosol, i.e. using adjusted operational settings without disabling the device, and a disabling signal causing disabling the device to generate aerosol, i.e. using adjusted operational settings causing disabling the device to generate aerosol. According to the different embodiments of the invention, the control signal can be generated by a distant server, a local server, a scan terminal, a mobile device or the aerosol generation device.

As used herein, the term “aerosol” may include a suspension of precursor as one or more of: solid particles; liquid droplets; gas. Said suspension may be in a gas including air. Aerosol herein may generally refer to/include a vapor. Aerosol may include one or more components of the precursor.

As used herein, the term “aerosol-forming precursor” or “precursor” or “aerosol-forming substance” or “substance” or “payload” may refer to one or more of a: liquid; solid; gel; mousse; other substance. The precursor may be processable by an atomizer of the device to form an aerosol as defined herein. The precursor may comprise one or more of: nicotine; caffeine or other active component. The active component may be carried with a carrier, which may be a liquid. The carrier may include propylene glycol or glycerine. A flavoring may also be present. The flavoring may include Ethylvanillin (vanilla), menthol, Isoamyl acetate (banana oil) or similar. A solid aerosol forming substance may be in the form of a rod, which contains processed tobacco material, a crimped sheet or oriented strips of reconstituted tobacco (RTB).

As used herein, the term “emission restrictions” may refer to one or more components of the aerosol generated by the device, which is not authorized or limited in a given area. These components can be Nicotine, Hoffmann analytes, Formaldehyde, metal substance such as chromium, lead, nickel, etc.

The emission restrictions may concern the total amount of the component generated in the period of using of the device or in any other predetermined period such for example a predetermined number of puffs (10 puffs, 20 puffs, 30 puffs, 40 puffs, 50 puffs, etc.), or a part of the component in the aerosol. The restrictions may be presented by thresholds relative to the corresponding components of the aerosol. These thresholds may be expressed in mass unities, volume unities and/or part unities such “%” for example. These unities can be expressed per puff or per predetermined number of puffs as explained above.

The emission restrictions may vary according to the area (country, region, city, restricted area, etc.).

The emission restrictions may be defined by authorities for a given restricted area or any other administration responsible for the restricted area. The restrictions may depend on external parameters, such as time, day of the week, season, weather, pollution level, special using of the restricted area, etc. The restrictions may be updated in real time or according to a predetermined period. The emission restrictions may reflect test measures performed to obtain an emission test report relative to a particular brand and/or model of the aerosol generation device or any other device characteristic such for example its identifier.

As used herein, the term “test report” or “emission test report” may refer to a test or a series of tests performed in relation with a particular brand and/or model of an aerosol generation device or any other device characteristic such for example its identifier, notably to obtain an authorization from market authorities, for example before launching the aerosol generation device to the market. These tests are for example conducted to measure the quantity of components in the aerosol generated by one or several aerosol generation devices representative of the given brand and/or model or any other device characteristic. The measures may concern the total amount of the component generated in the period of using of the device or in any other predetermined period such for example a predetermined number of puffs (10 puffs, 20 puffs, 30 puffs, 40 puffs, 50 puffs, etc.), or a part of the component in the aerosol. These measures may be expressed in mass unities, volume unities and/or part unities such “%” for example. These unities can be expressed per puff or per predetermined number of puffs as explained above. Each test report may be stored in a distant database of the market authorities and/or the device and/or substance manufacturer. This database can be publically accessible.

As used herein, the term “restricted area” may refer notably to a movable area which may be a transport means, notably a public transport means like a bus, a train, an aircraft, etc. or an individual transport means like a car.

As used herein, the term “mobile device” may refer to a device, which is able to establish a data connection with the aerosol generation device. Advantageously, the computing device is also able to establish a connection with a distant server via for example a global computer network as Internet. The mobile device includes human-computer interaction means such a touch screen or a screen associated with control means, to allow a user to communicate with the distant server and with the aerosol generation device. Thus, the mobile device may be a smartphone, a laptop, a personal computer, a tablet, a smartwatch or all other connected device. In some cases, the mobile device can determine adjustable operational settings for the associated aerosol generation device.

As used herein, the term “distant server” may refer to one or several computers able to provide a distant service such for example an updatable database. The distant service can be required by a user via the aerosol generation device, the mobile device associated to this aerosol generation device or a scan terminal. In some cases, the distant server can determine adjustable operational settings for the aerosol generation device for which a service has been required. In some embodiments, the distant server can determine emission composition of the aerosol using for example only the brand and/or model of the aerosol generation device or any other device characteristic such for example its identifier. In this case, the distant server is for example able to access to the emission test report relative to this brand and/or model of the aerosol generation device or any other device characteristic.

As used herein, the term “updatable database” may refer to a database stored locally or distantly and defining control characteristics of aerosol generation devices authorizing or non-authorizing using the corresponding aerosol generation device according to the emission restrictions in the restricted area. Each control characteristic of the updatable database can refer to a brand and/or model of the aerosol generation device authorized or non-authorized to be used in the restricted area according to the emission restrictions, an aerosol generation device identifier authorized or non-authorized to be used in the restricted area according to the emission restrictions, a payload identifier authorized or non-authorized to be used in the restricted area according to the emission restrictions, or thresholds of authorized emission composition of the aerosol. In this last case, the thresholds of authorized emission composition of the aerosol may comprise a threshold for each component of the generated aerosol. Such a threshold may concern the total amount of the component generated in the period of using of the device or in any other predetermined period such for example a predetermined number of puffs (10 puffs, 20 puffs, 30 puffs, 40 puffs, 50 puffs, etc.), or a part of the component in the aerosol. These measures may be expressed in mass unities, volume unities and/or part unities such “%” for example. These unities can be expressed per puff or per predetermined number of puffs as explained above.

As used herein, the term “device characteristic” may refer to a brand and/or model of the aerosol generation device, an aerosol generation device identifier (including or not information indicating brand or model of the device), a payload identifier or an emission composition of the aerosol.

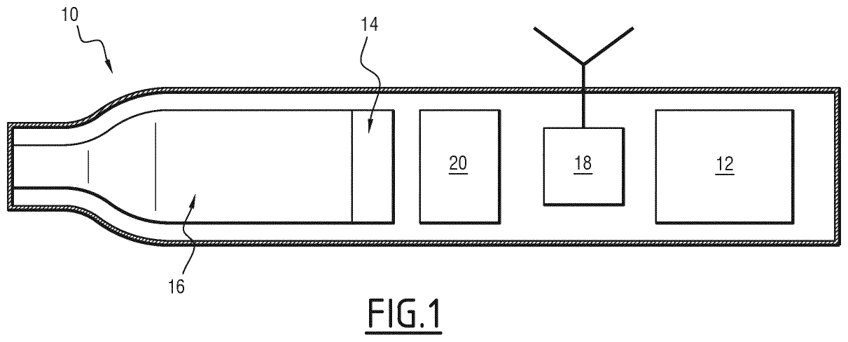

Referring to FIG. 1, an aerosol generation device 10 used in the different embodiments of the invention will be first explained.

Particularly, the aerosol generation device 10 comprises a battery 12 for powering the device, a heating system 14 powered by the battery 12, a payload compartment 16 in contact with the heating system 14, a communication unit 18 connecting the aerosol generation device 10 to at least one external device and a control unit 20 controlling the operation of the device. The aerosol generation device 10 may further comprise other components performing different functionalities of the device 10. These other components are known per se and will be not explained in further detail below.

The battery 12 is for example a known battery designed to be charged using the power supply furnished by an external charger and to provide a direct current of a predetermined voltage.

The payload compartment 16 is designed to store the precursor used to generate aerosol. Particularly, based on the nature of the precursor, the payload compartment 16 can be designed to store the precursor in a liquid and/or solid form. The payload compartment 16 can be fixed in respect with the body of the aerosol generation device 10 or removable from it. In the first case, the payload compartment 16 can be refilled with the precursor. In the second case, the payload compartment 16 can present a replaceable cartridge (e.g., a pod or capsule containing e-liquid) or consumable (e.g., a tobacco rod) that can be removed and replaced by another one when the precursor is no longer available. In some embodiments, the replaceable cartridge can be also refilled with the precursor.

In some embodiments, the payload compartment 16 may comprise a payload identifier making it possible to determine the nature of the precursor and/or its composition. The payload identifier can be transmitted to the control unit 20 and used by this unit, as it will be explained below. For example, in case of a replaceable cartridge, the payload identifier can be transmitted electronically and/or mechanically to the control unit 20. In case of a refillable payload compartment 16, the payload identifier can be determined and transmitted to the control unit 20 by appropriate electronic means. In some other embodiments, the payload identifier is transmitted by a user using an appropriate human-machine interface. Such an interface can be for example integrated directly into the aerosol generation device or into a mobile device associated with the aerosol generation device.

The heating system 14 comprises a heater in contact with the payload compartment 16 or integrated partially into this compartment 16. Powered by the battery 12 and controlled by the control unit 20, the heater is able to heat the precursor comprised in the payload compartment 16 to generate aerosol.

The control unit 20 is able to control the operation of the aerosol generation device 10, using operational settings. Particularly, using the operational settings, the control unit 14 is able to control the heater temperature and/or the power provided from the battery 12 to the heating system 14 and/or the pressure for example at the air inlet or aerosol outlet.

In some cases, the control unit 20 is also able to control the composition of the aerosol, by controlling for example the heater temperature and/or the heating duration and/or the operation of other components of the aerosol generation device 10 in an appropriate way.

In some embodiments, the control unit 20 is also able to determine at least one characteristic of the aerosol generation device 10. In particular, the device characteristic is an inherent characteristic of the device. In other words, the device characteristic essentially belongs the device and is inseparable from the device. As mentioned above, this characteristic may comprise a device brand and/or model, a device identifier, a payload identifier and/or an emission composition of the aerosol. Such a characteristic is for example securely stored in a memory of the control unit 20.

Advantageously, the memory of the control unit 20 is also able to store normal operational settings of the device 10, i.e. the operational settings corresponding to a normal operation of the device 10.

The communication unit 18 is configured to perform for example short-range wireless communications with an external device such as a mobile device or a scan terminal or any other electronic device, when such a device is in a close position with the aerosol generation device 10. Thus, the communication unit 18 is able to perform one of the known short-range communication protocols such as Bluetooth, RFID, NFS, etc.

In some embodiments, the communication unit 18 is further configured to perform long-range wireless communications with any electronic device. Thus, the communication unit 18 is able to perform communications using one of the known long-range protocols such as Wi-Fi, LoRa, 3G, 4G, 5G, etc.

According to some embodiments, the communication unit 18 is configured only to receive data from an external device. In some other embodiments, the communication unit 18 is configured to receive data from an external device and to transmit data to such a device.

Finally, according to some embodiments, the communication unit 18 is configured to perform wire communications with an appropriate device, e.g., via a USB cable.

### First Embodiment of the Invention

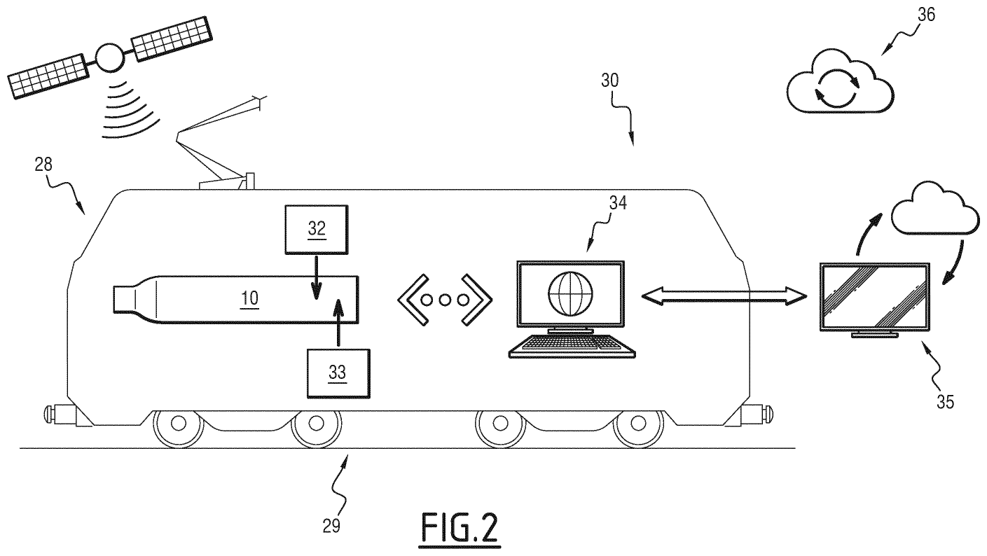

A system for preventing a non-authorized using of the aerosol generation device 10 as explained above, in a restricted area, according to a first embodiment of the invention, will now be explained in reference to FIG. 2. This system is called hereinafter preventing system and denoted by reference 30 on this figure.

As explained above, the restricted area is notably a movable area like a transport mean. In the example of FIG. 2, the restricted area is presented by a railway wagon 28 travelling on a railway track 29.

As it is showed on FIG. 2, the preventing system 30 comprises a speed determining module 32, a disabling/enabling module 33, at least one scan terminal 34 and a distant server 36.

The speed determining module 32 is associated with the aerosol generation device 10 and is able to determine a travelling speed of this device 10. In the example of FIG. 2, the speed determining module 32 is integrated into the aerosol generation device 10. According to another example, the speed determining module 32 is integrated into a mobile device associated with the aerosol generation device 10 and notably, able to communicate with this device 10 via the communication unit 18. According to another example, the speed determining module 32 is associated with the restricted area and the travelling speed determined by this module corresponds to the travelling speed of the restricted area. In this last case, it is considered that the travelling speed of the aerosol generation device 10 is significantly equal to the travelling speed of the restricted area.

The speed determining module 32 is for example a GNSS receiver able to receive signals from a Global Navigation Satellite System like the GPS system for example, in order to determine the travelling speed of the aerosol generation device 10. According to other examples, the speed determining module 32 presents any other suitable means able to determine the travelling speed of the aerosol generation device 10.

The disabling/enabling module 33 is able to determine a control signal for the control unit 20 of the aerosol generation device 10 causing enabling or disabling the device 10 to generate aerosol, basing on the speed of the device 10. For this purpose, the disabling/enabling module 33 is connected to the speed determining module 32 and is able to receive the travelling speed determined by this module 32.

Particularly, if the travelling speed of the aerosol generation device 10 is above a predetermined threshold or equal to this threshold, the disabling/enabling module 33 is adapted to generate a first control signal causing disabling the aerosol generation device to generate aerosol. If the travailing speed is below said predetermined threshold, the disabling/enabling module 33 is adapted to generate a third control signal causing enabling the aerosol generation device 10 to generate aerosol.

Said predetermined threshold is greater than average of the walking or running speed of a person or corresponds to a maximum running speed of a person. For example said predetermined threshold can be greater than 5 km/h, advantageously greater than 10 km/h. According to some examples, said predetermined threshold corresponds significantly to an average travelling speed of the restricted area or eventually to a minimal travelling speed of the restricted area. Said predetermined threshold is used as a boundary to differentiate situations when the device travels on public transport (e.g., a tram or a train) and situations when the device moves by walking speed. For example, the predetermined threshold can be e.g., 15 km/h, or 20 km/h, or 25 km/h depending on local traffic conditions. As it will be explained later in further detail, as long as the speed determining module 32 detects a speed above the threshold, the device will be disabled to generate aerosol from that time point and remains disabled even if the speed is lowered down below the threshold unless receiving a control signal to enable its use (second or third control signal).

According to an advantageous example of the invention, the disabling/enabling module 33 is adapted to generate the third control signal causing enabling the aerosol generation device 10 to generate aerosol if the travelling speed is below the threshold for a time period longer than a predetermined time threshold. This predetermined time threshold is chosen for example depending on the restricted area.

Thus, for example, if the restricted area is a transport means, the predetermined time threshold corresponds to an average duration of a stop due for example to the traffic congestion, traffic lights or regular stops for allowing passenger exists and/or entries. This predetermined time threshold is for example equal to 1 minute, 2 minutes, 5 minutes, 10 minutes, etc.

As the speed determining module 32, the disabling/enabling module 33 is integrated into the aerosol generation device 10 according to the example of FIG. 2. According to other examples, the aerosol generation device 10 in integrated into a mobile device associated with the aerosol generation device. In this last case, the disabling/enabling module 33 is able to transmit the control signals to the control unit 20 via the communication unit 18.

According to a particular example of the invention, the speed determining module 32 and the disabling/enabling module 33 form a unique module integrated into the aerosol generation device 10 or into a mobile device associated with the aerosol generation device or into any other suitable mean.

The scan terminal 34 is for example disposed at the entrance to the restricted area. Particularly, when the restricted area is the railway wagon 28, the scan terminal 34 is disposed near a door of the wagon. In variant, several scan terminals 34 are disposed in different zones of the restricted area. For example, a scan terminal 34 can be disposed near each door of the railway wagon 28. According to some examples, the scan terminal 34 can be combined with any other terminal already presented in the restricted area, as for example a validation terminal.

The terminal 34 is configured to scan the aerosol generation device 10 in order to determine at least one device characteristic. For this purpose, the scan terminal 34 comprises a communication unit able to exchange data with the communication unit 18 of the aerosol generation device 10. Particularly, the communication unit of the scan terminal 34 is able to read at least one characteristic of the aerosol generation device and to transmit to the communication unit 18 of the aerosol generation device 10 a control signal.

The scan terminal 34 is for example connected by wire or wirelessly to a local server 35. The local server 35 is able to communicate with the scan terminal 34 and with the distant server 36 in order to exchange data between the terminal 34 and the distant server 36. Particularly, the local server 35 allows transmitting the characteristic of the aerosol generation device 10 scanned by one of the terminals 34 to the distant server 36 and transmitting a control signal generated by the distant server 36 to the terminal 34.

In variant, the scan terminal 34 is connected directly to the distant server 36 and is able to exchange directly data with this distant server 36.

The distant server 36 is for example a cloud server comprising an updatable database as defined below. Particularly, the distant server 36 is able to receive at least one characteristic of the aerosol generation device 10 and to compare this characteristic with the updatable database. Further to this comparison, the distant server 36 is able to transmit to the aerosol generation device 10 eventually via the local server 35 and via the scan terminal 34, a second control signal. This second control signal may comprise an enabling command or an adjusting command or adjusted operational settings.

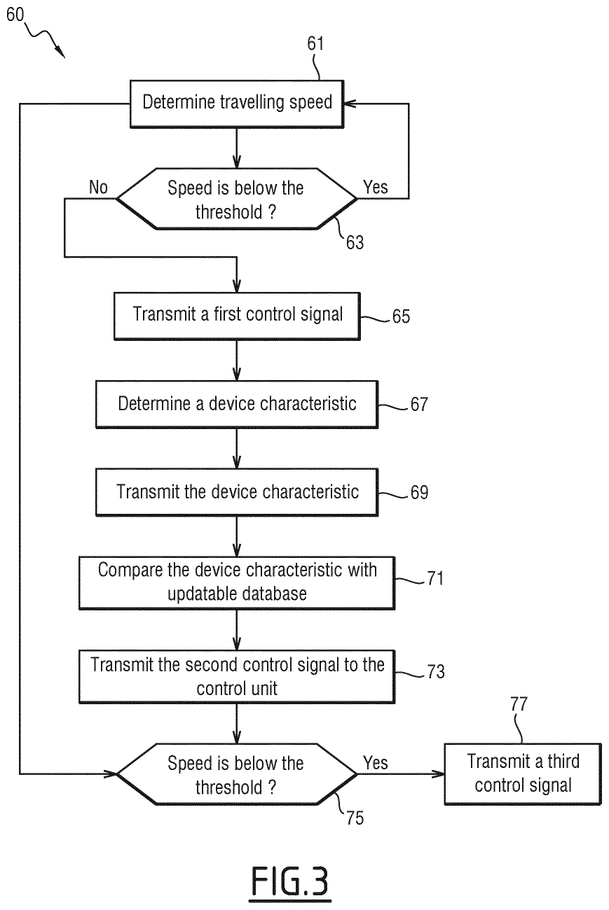

The preventing system 30 according to the first embodiment of the invention is able to perform a method 60 for preventing a non-authorized using of the aerosol generation device 10 which will be now explained in reference to FIG. 3.

Initially, it is considered that the aerosol generation device 10 is out of the restricted area.

During the step 61 performed for example continuously or periodically, the speed determining module 32 determines the travelling speed of the aerosol generation device 10 and transmits it to the disabling/enabling module 33. In case when the speed is determined periodically, it can be done according to a predetermined frequency (e.g., every minute or 5 minutes).

During the next step 63, the disabling/enabling module 33 analyses the travelling speed and if this speed is below the predetermined threshold so far, no action is performed.

Otherwise, i.e. if the speed is detected, at some time point or for a period, to be above the predetermined threshold or equal to this threshold, the disabling/enabling module 33 determines during the step 65 that the aerosol generation device 10 is in the restricted area such as a public transport, and transmits to the control unit 20 the first control signal, i.e. a signal comprising a disabling command. Upon receiving the first control signal, the control unit 20 disables the capacity of the aerosol generation device 10 to generate aerosol. Other functionalities of the aerosol generation device 10 can be kept unchanged.

During the next step 67, performed when for example a user scans the aerosol generation device 10 by bringing it to a close position with the scan terminal 34, at least one device characteristic of the aerosol generation device 10 is determined. Thus, a first data exchange is performed between the communication units of the aerosol generation device 10 and the scan terminal 34. This first data exchange comprises transmitting at least one device characteristic to the scan terminal 34.

During the next step 69, the scan terminal 34 transmits the device characteristic to the distant server 36, eventually via the local server 35.

During the next step 71, the distant server 36 receives the device characteristic and compares it with the updatable database and notably, with the corresponding control characteristic(s) to generate a second control signal. The second control signal comprises an enabling command or an adjusting command or adjusted operational settings.

Thus, for example, if the transmitted characteristic is the brand and/or model of the aerosol generation device 10, the distant server compares this brand and/or model with a list of authorized or non-authorized brands or models of the updatable database.

If the transmitted characteristic is the emission composition of the aerosol generated by the device 10, the distant server 36 compares this emission composition with the corresponding emission thresholds of the updatable database. Based on this comparison, the distant server 36 generates the corresponding control signal.

In some embodiments, during this step 71, the distant server 36 can determine or retrieve emission composition of the aerosol using for example only the brand and/or model of the aerosol generation device 10 or any other device characteristic such for example its identifier. In this case, the distant server 36 is for example able to access to an emission test report relative to this the brand and/or model of the aerosol generation device or any other device characteristic, in order to determine the emission composition of this device. Then, the distant server 36 can compare this emission composition with the corresponding emission thresholds of the updatable database. If for example the quantity of each component of the aerosol is less than the corresponding threshold in the updatable database, then the aerosol generation device is authorized to be used in the restricted area. If for example the quantity of at least one component of the aerosol is greater than the corresponding threshold in the updatable database, then the aerosol generation device is not authorized to be used in the restricted area.

For example, the updatable database can include a threshold relative to the quantity of Nicotine authorized in the restricted area. This quantity can be equal for example to 50 μg per 20 puffs. Thus, if according to an emission test report, the aerosol generated by the aerosol generation device contains 22.3 μg of Nicotine per 20 puffs, such a device can be authorized for using in the restricted area if the quantity of the other aerosol components are also less than the corresponding threshold. If according to the emission test report, the aerosol generated by the aerosol generation device contains 74.4 μg of Nicotine per 20 puffs, such a device cannot be authorized for using in the restricted area.

During the next step 73, the distant server 36 transmits the second control signal to the communication unit 18 of the aerosol generation device 10 using for example the scan terminal 34 and the local server 35. In this case, it is considered that the aerosol generation device 10 is still in a close position with the scan terminal 34 which is able to perform a second data exchange. According to other embodiments, the second control signal may be transmitted to the aerosol generation device 10 using any other suitable way, for example using the long-range communication capacities of the communication unit 18.

Upon receiving the second control signal, the communication unit 18 of the aerosol generation device 10 transmits it to the control unit 20. The control unit 20 processes this control signal and determines the corresponding action which may comprise enabling aerosol generation capacity of the aerosol generation device 10, keeping it unchanged or adjusting the operational settings. In this last case, the control unit 20 may determine the adjusted operational settings using for example a pre-programmed routine or use adjusted operational settings comprised in the second control signal.

During the next step 75, performed for example continuously after the step 73, the disabling/enabling module 33 analyses again the travelling speed of the aerosol generation device 10.

If this speed is above the predetermined threshold or equal to this threshold, this means that the aerosol generation device 10 is still in the restricted area and no action will be performed. Otherwise, i.e. if the travelling speed is below the threshold, the disabling/enabling module 32 determines that the aerosol generation device 10 is no longer in the restricted area. So, it generates during the step 77 a third control signal comprising enabling command.

This signal is transmitted to the control unit 20 which enables normal operation of the aerosol generation device.

According to an advantageous example of the invention, the step 77 is performed only if the travelling speed is below the threshold for a time period longer than the predetermined time threshold explained above.

It should be noted that the steps of the preventing method 60 can be performed according to a different order.

For example, the steps 65 to 73 can be performed before the step 61. This is notably the case when the user performs scanning the aerosol generation device 10 upon entering the restricted area which is not yet in movement. So, the second control signal can be transmitted to the control unit 20 of the device before the first control signal. Thus, when the restricted area is in movement, the first control signal is transmitted to the control unit 20 but it has no effect if the second control signal causes normal or adjusted operation of the aerosol generation device 10. Hence, the second control signal prevails over the first control signal.

### Second Embodiment of the Invention

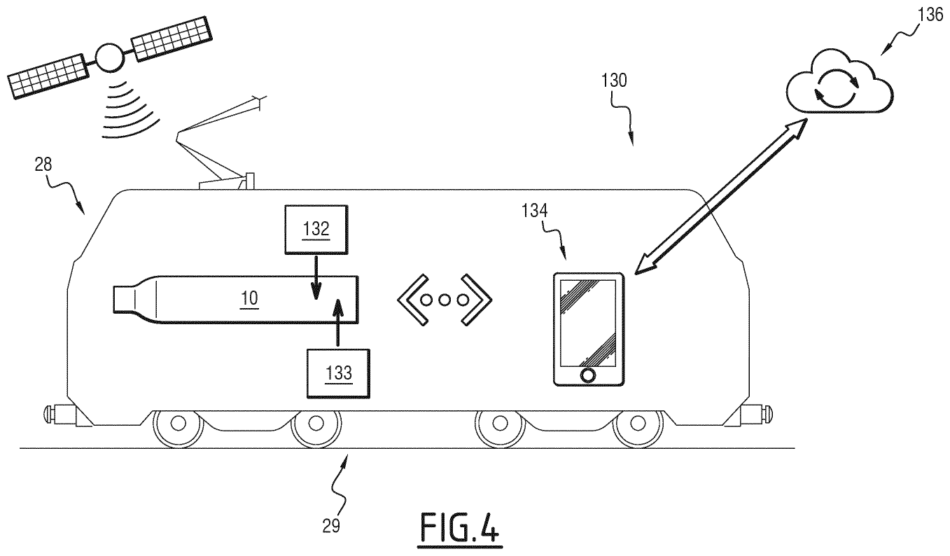

A system for preventing a non-authorized using of the aerosol generation device 10 as explained above, in a restricted area, according to a second embodiment of the invention, will now be explained in reference to FIG. 4. This system is called hereinafter preventing system and denoted by reference 130 on this figure.

As in the previous embodiment, the restricted area is presented by the railway wagon 28 travelling on the railway track 29.

In reference to FIG. 4, the preventing system 130 comprises a speed determining module 132, a disabling/enabling module 133, a mobile device 134 associated to the aerosol generation device 10 and a distant server 136.

The speed determining module 132, the disabling/enabling module 133 and the distant server 136 are similar respectively to the speed determining module 32, the disabling/enabling module 33 and the distant server 36 explained above in reference to the first embodiment. Particularly, as in the previous case, the speed determining module 132 and the disabling/enabling module 133 can be integrated into the aerosol generation device 10 as it is showed on FIG. 4 and/or into the mobile device 134.

According to this embodiment, the mobile device 134 has the similar functionalities as the scan terminal 34 according to the first embodiment of the invention.

Particularly, the mobile device 134 is configured to determine at least one device characteristic of the aerosol generation device 10. For this purpose, the mobile device 134 comprises a communication unit able to exchange data with the communication unit 18 of the aerosol generation device 10. Thus, the device characteristic can be transmitted from the communication unit 18 of the aerosol generation device 10 to the communication unit of the mobile device 134. According to another example, the mobile device 134 is able to determine the device characteristic by analyzing an image of at least a portion of the aerosol generation device 10. The image can be for example captured using a photo/video camera integrated into the mobile device 134.

The mobile device 134 is also able to transmit the determined device characteristic to the distant server 136 and to receive from this server 136 the corresponding control signal. This data exchange is performed using for example long-range communication capacities of the mobile device 134. Eventually, in certain cases, a local server connected to the distant server 136 can also be used. In this case, the mobile device 134 can be wirelessly connected to the local server using for example the WiFi protocol.

The preventing system 130 according to the second embodiment of the invention is able to perform a method for preventing a non-authorized using of the aerosol generation device 10 which is similar to the preventing method 60 explained above. The only difference is that the steps 67 and 69 performed by the scan terminal 34 according to the first embodiment of the invention are performed by the mobile device 134 according to the second embodiment of the invention.

### Third Embodiment of the Invention

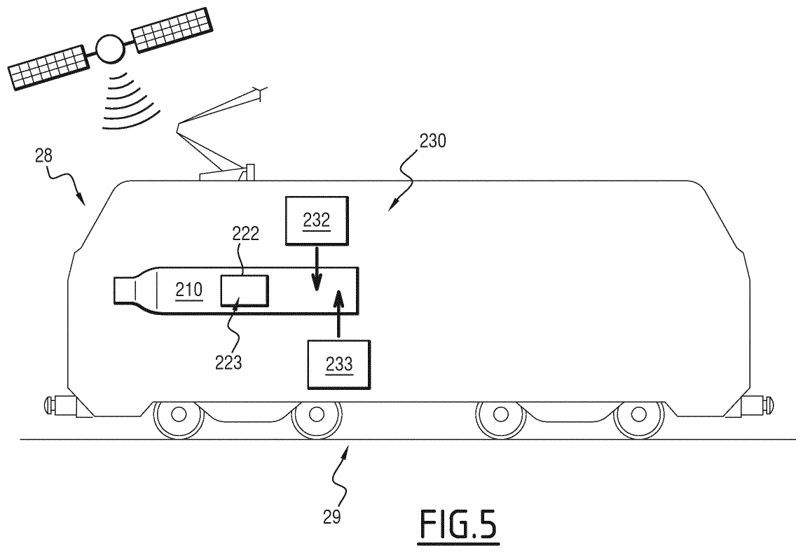

A system for preventing a non-authorized using of an aerosol generation device in a restricted area, according to a third embodiment of the invention, will now be explained in reference to FIG. 5. This system is called hereinafter preventing system and denoted by reference 230 on this figure.

As in the previous embodiments, the restricted area is presented by the railway wagon 28 travelling on the railway track 29.

In reference to FIG. 5, the preventing system 130 comprises an aerosol generation device 210, a speed determining module 232 and a disabling/enabling module 233.

The speed determining module 232 and the disabling/enabling module 233 are similar respectively to the speed determining module 32 and the disabling/enabling module 33 explained above in reference to the first embodiment. Particularly, as in the previous cases, the speed determining module 232 and the disabling/enabling module 233 can be integrated into the aerosol generation device 210 as it is showed on FIG. 4 and/or into a mobile device associated to the aerosol generation device 210.

The aerosol generation device 210 is similar to the aerosol generation device 10 explained above and comprises at least the same components 12 to 20 as those explained above. Further, according to this embodiment, the aerosol generation device 210 comprises a processor 222 able to perform at least one pre-programmed routine, called hereinafter verification routine 223.

Additionally, according to this embodiment, the control unit 20 of the aerosol generation device 210 can further comprise a memory able to store the updatable database as explained above. This database can for example include thresholds of authorized emission composition of the aerosol in each known area and can be updated periodically using the communication unit 18.

According to another example of implementation, the updatable database is stored distantly. In this case, the control unit 20 of the device 210 is able to access to this database via the communication unit 18.

The preventing system 230 according to the third embodiment of the invention is able to perform a method for preventing a non-authorized using of the aerosol generation device 210 which is similar to the preventing method 60 explained above. The only difference is that the steps 67, 71 and 73 performed by the scan terminal 34 and the distant server 36 according to the first embodiment of the invention are performed by the verification routine 223 of the aerosol generation device 210, and in that the step 69 of transmitting the device characteristic to a distant server is not performed.

Particularly, during a step similar to the step 67 of the first embodiment of the invention, the verification routine 223 determines a device characteristic. According to this embodiment, this step can be performed upon receiving a first control signal from the disabling/enabling module 233 or before receiving this first control signal or even before entering the restricted area.

During the next step similar to the step 71 of the first embodiment of the invention, the verification routine 223 compares the device characteristic with the updatable database and generates a second control single basing on this comparison.

Finally, during the next step similar to the step 73 of the first embodiment of the invention, the verification routine 223 transmits the second control signal to the control unit 20 of the aerosol generation device 210. Like in the previous cases, if a first control signal is received after receiving the second control signal, this first control signal has not effect. In other words, the second control signal prevails over the first control signal.

### Other Embodiments of the Invention

Other embodiments of the invention are still possible. These embodiments can combine different features of the previously described embodiments.

According to some embodiments, the control signal causing enabling, disabling or adjusting operation of the aerosol generation device can be generated basing further on restrictions other than the emission restrictions. These other restrictions can also concern the area or the user.

1. A method (60) for preventing a non-authorized using of an aerosol generation device (10; 210) in a restricted area, the aerosol generation device (10; 210) comprising a control unit (20) configured to adjust the operation of the aerosol generation device (10; 210) according to operational settings upon receiving a control command;
the method (60) comprising the following steps:
determining (61) a travelling speed of the aerosol generation device (10; 210);
if the travelling speed of the aerosol generation device (10; 210) is above a predetermined threshold or equal to this threshold, determining (65) that the aerosol generation device (10; 210) is in the restricted area and transmitting to the control unit (20) of the device a first control signal causing disabling the aerosol generation device (10; 210) to generate aerosol;
determining (67) a device characteristic of the aerosol generation device (10; 210);
comparing (71) the device characteristic of the aerosol generation device (10; 210) with an updatable database to generate a second control signal, the database comprising control characteristics defining restrictions in the restricted area;
transmitting (73) to the control unit (20) of the aerosol generation device (10; 210) the second control signal, the second control signal causing normal operation of the aerosol generation device or adjusted operation the aerosol generation device in the restricted area according to the restrictions of the restricted area.

2. The method (60) according to claim 1, further comprising the following step:
if the travailing speed is below said predetermined threshold, preferably during a time period longer than a predetermined time threshold, transmitting (77) to the control unit (20) of the aerosol generation device (10; 210) a third control signal causing enabling normal operation of the aerosol generation device (10; 210).

3. The method (60) according to claim 1 or 2, wherein the travelling speed is determined using a GNSS receiver.

4. The method (60) according to any one of the preceding claims, wherein the step (61) of determining the travelling speed is performed by the aerosol generation device (10; 210) or by a mobile device (134) associated to the aerosol generation device (10; 210).

5. The method (60) according to any one of the preceding claims, wherein the step (67) of determining the device characteristic is performed by a processor of the aerosol generation device (210) by a pre-programmed routine (223).

6. The method (60) according to any one of claims 1 to 4, wherein the step (67) of determining the device characteristic is performed by a scan terminal (34) disposed in the restricted area by scanning the aerosol operation device (10) or a mobile device associated to the aerosol generation device (10).

7. The method (60) according to any one of the preceding claims, further comprising the step (69) of transmitting the device characteristic to a distant server (36; 136).

8. The method (60) according to claims 6 and 7, wherein the step (69) of transmitting the device characteristic is performed by the scan terminal (34).

9. The method (60) according to claim 7, wherein the step (69) of transmitting the device characteristic is performed by the aerosol generation device (10) or a mobile (134) device associated to the aerosol generation device (10).

10. The method (60) according to any one of the preceding claims, wherein each control characteristic of the updatable database comprises at least one element chosen in the group comprising:
brand and/or model of aerosol generation devices authorized or non-authorized to be used in the restricted area according to the emission restrictions;
identifier of aerosol generation devices authorized or non-authorized to be used in the restricted area according to the emission restrictions;
identifier of payloads authorized or non-authorized to be used in the restricted area according to the emission restrictions;
thresholds of authorized emission composition of the aerosol.

11. The method (60) according to any one of the preceding claims, wherein the device characteristic comprises at least one element chosen in the group comprising:
brand and/or model of the aerosol generation device;
identifier of the aerosol generation device;
identifier of the payload;
emission composition of the aerosol.

12. The method (60) according to any one of the preceding claims, wherein adjusting the operation of the aerosol generation (10; 210) device includes at least one element chosen in the group comprising:
heater temperature control;
aerosol composition control;
power control;
pressure control.

13. The method (60) according to any one of the preceding claims, wherein the restricted area is a public transport.

14. The method (60) according to any one of the preceding claims, wherein the second control signal prevails over the first control signal.

15. A system (30; 130; 230) for preventing a non-authorized using of an aerosol generation device (10; 210) in a restricted area, configured to perform the method (60) according to any one of the preceding claims.
